(19) United States
(12) Patent Application Publication
(10) Pub. No.: US 2008/0243699 A1
(43) Pub. Date: Oct. 2, 2008

(54) License optimization and automated management

(75) Inventors: Israel Hilerio, Kenmore, WA (US); Eric B. Watson, Redmond, WA (US); Lingan Satkunanathan, Kirkland, WA (US); Krishna Sunkammurali, Sammamish, WA (US); Bjorn B. Levidow, Bellevue, WA (US); Nisheeth Srivastava, Redmond, WA (US); Bruce L. Johnson, Woodinville, WA (US); Murali Vajjiravel, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/729,589

(22) Filed: Mar. 29, 2007

(51) Int. Cl. G06Q 10/00

(52) U.S. Cl. 705/59; 705/58

(57) ABSTRACT

A license management system may include a license analyzer that is capable of evaluating different licensing strategies for software products or services on a single device or a group of devices. Rules for licensing options are coupled with actual usage data and forecasts to determine various licensing options. The options may be implemented by an automated system for renewing licenses or changing licenses and installing updated licenses.

### BACKGROUND

There are many different types of licenses for computer-related applications, software, and services. Perpetual licenses may be purchased for stand alone applications, operating systems, or other software that operates on a local device. Shared licenses may be issued for applications that are delivered over a network or are used on different devices on the network. Some services may be offered on a per-use license and operate on a local device or delivered through the Internet from a remote server. Still other licenses may be time limited, such as a subscription that may be periodically renewed.

Several such options may be available for a particular software product or service. For example, a software product may be available for purchase as a perpetual license or as a per-use basis as a service provided over the Internet. Determining which license scheme to use is often a confusing and complex affair.

### SUMMARY

A license management system may include a license analyzer that is capable of evaluating different licensing strategies for software products or services on a single device or a group of devices. Rules for licensing options are coupled with actual usage data and forecasts to determine various licensing options. The options may be implemented by an automated system for renewing licenses or changing licenses and installing updated licenses.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a system with a license analyzer.

FIG. 2 is a diagram of an embodiment showing the analysis and managing of licenses.

FIG. 3 is a flowchart illustration of an embodiment showing a method for managing licenses.

FIG. 4 is a diagram of an example of license option analysis.

### DETAILED DESCRIPTION

A license manager may create several license options for a group of licensed products using business rules, license option rules, and a history and forecast of usage for the licensed products. Various license options may be evaluated against a user's business rules to select an optimized solution. The license manager may implement the optimized solution by contacting a license provider, purchasing or returning licenses, updating a license pool, and installing any new licenses.

The license manager may be used to manage small or large groups of licenses, such as may be found in a business or institution where tens, hundreds, or even thousands of licensed products may be used. In such situations, license purchase options may be very complex and actual usage may be difficult to track and manage.

The license manager may use business rules and usage history that are unique to each situation to evaluate license options. Business rules may include any type of variable, script, formula, or other expression that defines how a particular business makes decisions. Usage history may be compiled over time and used to forecast future use in addition to projections for future use. In many cases, a license manager may compare options for licensed products that are stored and operated locally with similar services that may be provided over the Internet. The license manager may also be able to compare perpetual, one-price licenses with per-use licenses by evaluating the past and projected usage history.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

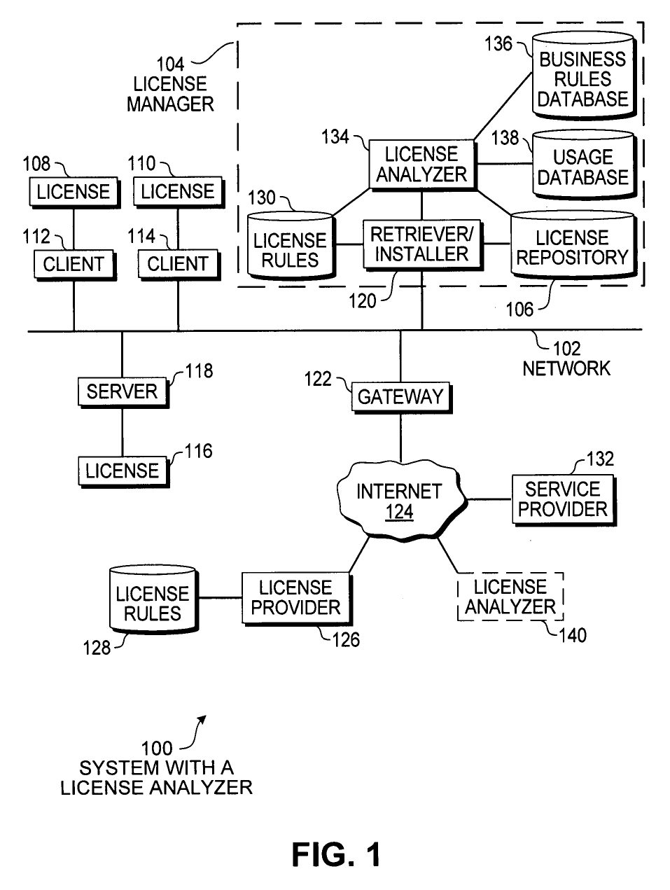

FIG. 1 is a diagram of an embodiment 100 showing a system with a license analyzer. Attached to the network 102 is a license manger 104 that contains a license repository 106. The license repository 106 maintains metadata for licenses 108 and 110 used by clients 112 and 114, respectively, as well as license 116 used by server 118.

A license manager 104 has a retriever/installer 120 that may communicate through a gateway 122 and Internet 124 to a license provider 126. The license provider 126 may have license rules 128 that may be retrieved and stored in a local license rules database 130.

In some instances, the various licenses 108, 110, and 116 may be for licenses for products operating on the respective devices or for a service provided through a service provider 132.

A license analyzer 134 may use a business rules database 136, a usage database 138, the license repository 106, and the license rules database 130 to generate several options for licensing. The licensing may be for a single device or for many devices, such as the clients 112 and 114 and server 118. In some instances, the functions of the license analyzer 134 may be provided through a remote license analyzer 140 that may be available through the Internet 124.

The license analyzers 134 and 140 may use several different pieces of data to generate several options for licensing a licensed product. The options may be used, for example, in a business that has growing or fluctuating uses for licensed products. In some cases, options may analyze and optimize choices based on usage history, forecasted usage, purchasing patterns, business rules, as well as the sometimes complex rules defining various licensing purchase options.

Once an option is selected, the installer 120 may contact a license provider 126, perform various transactions to update the license pool, and install updated licenses appropriately. In some embodiments, selection criteria of a license option may be predetermined and the licenses may be automatically updated based on a particular predetermined optimization.

The embodiment 100 may be a typical embodiment for a local area network that may be present in a business or home. In such a network the clients 112 and 114 and the server 118 may be personal computers or server computers. In other embodiments, the various devices that may operate or use licensed products include personal digital assistants, cellular telephones, media players, game consoles, network appliances, industrial controllers, or any other device capable of using a licensed product.

Licenses may be used for various licensed products. For example, some software applications, components, and operating systems may have licenses. Access to databases, media files, mailing lists, and other data sources may also be licensed. Additionally, many services may be performed over a network or the Internet may be distributed as licensed services. In some instances, a product may be available as a locally hosted application or product operating on a local device or a local server, or the product may also be available through a web-based or Internet-based service. In such a case, a thin client or other smaller application may be operating on a client device. In other cases, no specialized software or application is used and the service may be accessed through an operating system, a browser, or other multiple use product.

Licenses may take many different forms. Perpetual licenses are a common form used for operating systems and some software products that are loaded on and are operated by a server or client device. Some licenses may be shared across a network by different devices using a license distribution system. For example, some high cost applications such as computer aided design systems may have a shared license mechanism. An example of such a system may have the application installed on a client but a session cannot be started on the client device until a license is obtained from a local license repository. The license may be assigned to the client device until the session is terminated and the license is then free to be used by a different client.

Some license systems use a limited time license that may disable an application, service, or other product after a specific date, a period of time has elapsed, a certain number of uses has been exceeded, or some other criteria. Such a license may be renewed periodically.

Licenses may be assigned to a specific device or a specific user. Some products may be licensed to a specific user, such as a cellular telephone service, a license to media, or access to a service such as email or a customer resource management system. When a license is assigned to a specific device, multiple users may potentially use the device and the licensed product. When a license is assigned to a specific user, a single device may have separate licenses for each user of a product on a device.

Per-use licensing is a mechanism by which a user is licensed for each use of a product. For example, a media file may be evaluated on a license that enables a user to experience the media file for three times before the license expires. In another example, an email service may allow a user to send or receive a maximum amount of data or email. A third example may be the licensing of a cellular phone service where a user is permitted a fixed number of minutes of usage per month. If the user goes over the usage limit, the user may have additional charges.

When managing licenses over several devices, such as in a network environment, licenses may be purchased in bulk. For example, a company may have the option to purchase individual perpetual licenses for each of the many devices in the company or the company may be able to buy a bulk pack of licenses for a discount. When installed in the network, a license management system may distribute the bulk licenses from the license repository. Often in such situations there may be unused or unassigned licenses from time to time. In large networks with many licenses, the management of a license pool may be quite complex.

Some license agreements may have a provision for a user to return or disable a license. In some cases, such a license may be disabled and returned for a credit or for a new license that may be transferred to another device or user.

The license repository 106 may contain various metadata about licenses, including the type of license, expiration date (if any), description of licensed product, assigned device or user, number of unassigned licenses, or other such metadata. In some embodiments, the license repository 106 may contain keywords, serial numbers or some other unique identifier that may be transmitted to an assigned device and may be used to access the licensed product using the device.

The business rules database 136 may include various rules that describe the operation or important parameters about the user of the license analyzer 120. For example, business rules may include data about how purchases are treated for tax reasons, such as whether services are treated as expenses or purchased licenses may be capitalized and depreciated. Other business rules may include a company's budgeting cycle, the preference for specific types of licenses, and if there is a preference for cost optimization, performance optimization, or some other factor. The business rules in the business rules database 136 may be any type of rule, factor, or description that may be useful in generating and comparing licensing options.

The usage database 138 may contain actual usage and forecasted usage of the licensed products. In some instances where a license option is available on a per-use basis, the usage of a product may be tracked in a manner consistent with calculating a per-use license fee, even if the product is licensed in a perpetual license. In some cases, the usage of a license may be tied to the usage of a device. In such cases, usage data for a license may tracked in an indirect manner by tracking the general usage of a device or other measurable data point and assuming that the usage of a licensed product approximates that data point.

Usage data may be used to determine if a particular license is the most optimum configuration. For example, a perpetual license may be assigned to a device that is removed from service due to an equipment upgrade. By detecting that the device is no longer operational, the license may be reclaimed and transferred to another device that may use the license.

The retriever function of the retriever/installer 120 may connect with a remote license provider 126 to perform several functions. The retriever may contact the remote license provider 126 to retrieve license rules 128 when the license analyzer 134 may perform an analysis of the current state of licenses. In some instances, the remote license provider 126 may contact the retriever 120 and push new license rules 128 to the license rules database 130. An example of such an instance may be when the license rules 128 are updated or when a sale or special offer is made for future license purchases.

The retriever function may also contact the license provider 126 to obtain a new license, update a license, renew a license, or to return an unused license. The retriever function may perform a purchase of a license in some cases, such as using a credit card, automatic debit, or with an open purchase order.

The installer function of the retriever/installer 120 may reconfigure or install licenses on various devices. In some cases, the installer may push a new license key or other unique code directly to a client device 112 or 114. In other cases, the installer function may adjust the pool of available licenses.

The license provider 126 may be a server or other device that has an automated interface so that the retriever/installer 120 may perform various transactions. In some cases, the license provider 126 may be owned and operated by a software manufacturer while in other cases the license provider 126 may be operated by a third party license distributor. The license provider 126 may provide licenses for several different licensed products or for only one product.

The service provider 132 may provide any licensed product, including data and services, through the Internet 124 or some other network. In some situations, a licensed product may be available through an installed software or data component on a local device or as a service provided over the Internet 124. In some cases, a portion of a licensed product may be installed on a local device and a portion of the licensed product provided over the Internet 124. For example, a media system may comprise a software application on a local device that connects to a service on the Internet 124 for data. In still other cases, a service may be provided solely by a service provider 132, such as a word processing program that is accessed through a standard web browser.

The license manager 104 may be an application that operates on a device, such as a server device, attached to the network 102. In some embodiments, some or all of the elements of the license manager 104 may be provided by a remote server located over the Internet 124. For example, the license analyzer 134 and license rules 130 may be remote services provided over the Internet 124 on a remote server yet the business rules database 136, usage database 138, and license repository 106 may be located on a local device. In another example, the license rules 130 and usage database 138 may be remotely hosted and accessed through the Internet 124 by the license analyzer 134.

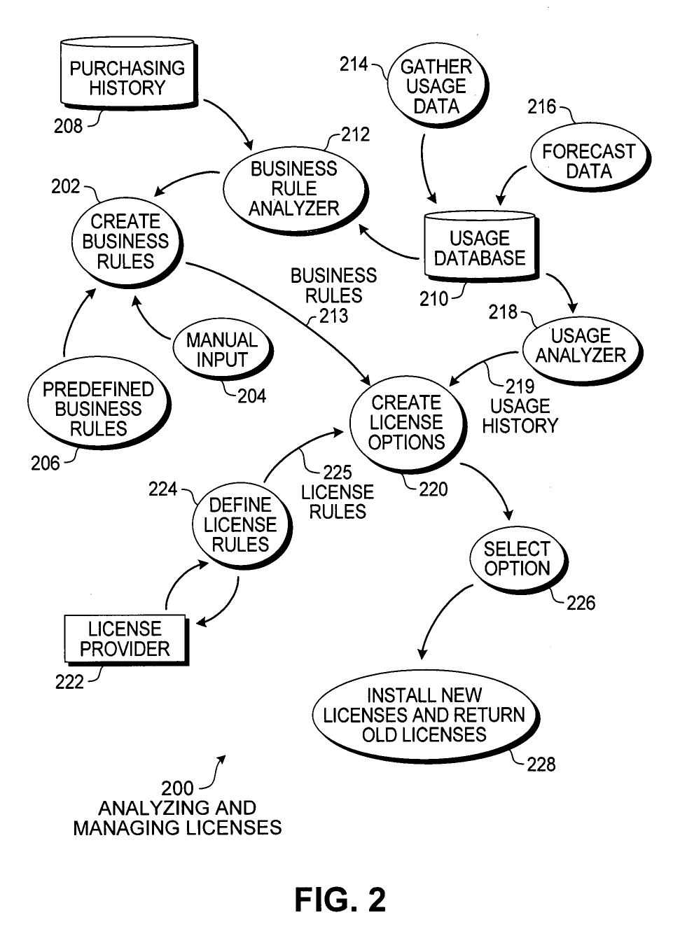

FIG. 2 is a diagram of an embodiment 200 showing the analyzing and managing of licenses. License options are created using business rules 202 among other items. Business rules may be created through manual input 204, selecting predefined business rules 206, or through the analysis of purchasing history 208 and usage databases 210 by a business rule analyzer 212.

Business rules are various settings, logic, and variables that may define certain characteristics used in analyzing licenses. In some instances, a business rule may be as simple as a fiscal year end, while in other instances, the business rules may include complex calculations and decision trees, formulas, or scripts that take into consideration taxes, uptime requirements, performance requirements, disaster planning, or any other consideration that may enter into the design of a licensing system.

Business rules may be input using manual input 204 by selecting rules from a list, answering a questionnaire, or creating scripts or other functions that describe a company's business policies. Some embodiments may also have predefined business rules 206 that are adapted to particular types of businesses. For example, a set of business rules may be defined for a business with a highly seasonal workforce such as a customer service business dealing with consumer products or a retail environment. Other business rules may be defined for a business with a low capital budget but has a strong cash flow. Still other predefined business rules may be tailored for startup companies that plan to grow from a certain number of employees to another number over a period of time. Business rules may be defined for specific industries, such as insurance or financial planning industries.

Predefined business rules may be selected and edited or customized for a particular business. A user may be able to combine portions of some predefined business rules with other sets of business rules to create a customized set of rules for the user's situation. For example, a user may operate a restaurant franchise business with two locations, and may select a set of business rules for restaurant franchises as a starting point. The user may also select some business rules from a high growth business because the user is anticipating opening additional franchises over a certain period of time. In some cases, a business's accountant may provide business rules or be able to tailor the business rules to suit specific tax or accounting situations.

Many business rules may be simple rules that make analysis of license options more customized and understandable for a particular user. For example, a set of business rules that define a fiscal year end and a semi-annual budgeting cycle may enable license options to be calculated on a six month period ending on the fiscal year end. In the example, some options presented near the fiscal year end may be designed to optimize year-end tax situations.

Purchasing history 208 may be used to infer some business practices. For example, if licensed products are purchased on an individual basis in a seemingly random pattern, license options may be presented that are more piecemeal in nature, focusing on purchasing what is immediately needed. In the example, license options may also be presented that consolidate existing licenses into bulk purchased licenses or other mechanisms that group certain licenses together to achieve a discount.

In another example, purchasing history 208 may be analyzed to determine that licensed products are purchased at regular intervals such as quarterly. From such purchases, a business rule may be implied that future purchases will happen quarterly, therefore license options will be presented on a quarterly basis.

Purchasing history 208 may be used to determine the current license situation when creating license options. The type of a purchased license and any conditions on the license may be used to determine potential options for analysis. An example of a condition on a license may be a return policy for the license, a transferability policy for the license, or other conditions. In some instances, information from the purchasing history 208 may be used to contact a license provider, which may provide a set of rules or definitions of any conditions on existing licenses.

Usage data is gathered 214 and stored in the usage database 210. The usage data may comprise any type of data that indicates usage for a licensed product. In some instances, the usage of a licensed product may be directly measured through the licensed product itself, which may have a usage reporting feature. In some instances, the usage may be recorded on the device or on a server that provides the licensed product and such data may be collected and stored in the usage database 210.

Usage data may be gathered using many different mechanisms. In one case, a licensed product may have a usage reporting function that reports to a license manager each time the licensed product is used and in what form the use takes place. A usage log may include a user, a device, description of the use, duration of the use, results of the use, or other data. In another case, a licensed product may keep a usage log in a data file in a predefined folder. A usage gathering mechanism within a license manager may connect to the particular device, navigate to the predefined folder, and collect information from the data file. The information may be translated, interpreted, transformed, pre-processed, or otherwise analyzed before being stored in the usage database 210.

When shared licenses are used by several client devices, a license delivery mechanism that distributes the shared licenses may provide usage data for the usage database 210. In some cases, the license delivery mechanism may write data directly into the usage database 210, while in other cases a license manger or other application may pull usage data from the license delivery mechanism.

Usage data may also comprise forecast data 216. The forecast data 216 may be derived and interpolated from past usage history or may be manually input based on forecasted license usage.

Forecast data 216 may be determined from usage history by analyzing usage history over a period of time and interpolating future changes. For example, a business may have seasonal changes in usage, such as a garden center, retail store, manufacturing plant, or other business. By analyzing usage over a period of a year or longer, the changes may be detected and licensing options may be developed and analyzed based on the predicted seasonal changes. An example of a license option that is tailored for a seasonal operation may include a set of perpetual licenses for devices that are used year round and a group of per-use licenses that are used during peak seasons. Such an option may be less expensive than purchasing perpetual licenses for each device, especially when many devices may sit idle for a long period of time.

Forecast data 216 may also be entered manually or otherwise determined by a user. A user may be able to predict or estimate changes in the number of needed licensed products over a period of time. The estimates or predictions may be entered in several scenarios that may be evaluated using different license options for each scenario. The forecast data 216 may be entered in the form of a spreadsheet, manual data entry, a questionnaire, or other form of input. In some embodiments, a user may be able to enter two or more different versions of forecast data 216 to analyze how licensing options may change based on the versions of forecast data 216.

A usage analyzer 218 may take data in the usage database 210 and generate usage history 219 that is in a useful form for analyzing license options. The usage analyzer 218 and usage history 219 may be used to evaluate a current licensing situation to compare to various licensing options. The usage history 219 may also be used to present a user's costs for licensing products over a period of time as compared to what a user's costs would have been with a different licensing option.

For example, a comparison of licensing options may include a cost analysis of the user's licensed products over the last year using two or more different licensing options. A user's actual history of purchasing several individual perpetual licenses over the period of time may be compared to a licensing option with bulk purchases of perpetual licenses made at certain periods of time, another licensing option may be an optimized balance of perpetual licenses and per-use licenses. The two options may be compared to the user's actual history of purchases and usage to determine which would have been a better alternative for the user. The cost analysis of each option may be presented to the user so that the user may determine an option for future licenses.

A license provider 222 may provide data so that license rules may be defined 224. The license rules 225 may include any format for any type of rules, cost structures, logic, conditions, or any other variable that may define license options. License rules 225 may include rules for different forms of license arrangements for a licensed product. For example, a set of license rules 225 may include rules for per-use licenses, service licenses provided over a network or Internet, bulk purchase licenses, per-user licenses, or any other version of licenses, even though a user may have perpetual licenses. In some situations, the set of license rules 225 may include special offer licenses arrangements that are available for a certain period of time.

The license rules 225 may also include rules that define how one license type may be changed to a different license type, or rules that define any costs or mechanisms used for moving a license from one device to another, or any other rule or mechanism used for transferring, returning, or changing a license.

License rules 225 may be defined in any manner that is useful in creating license options. In some cases, license rules 225 may include scripts, functions, formulas, or other complex expressions that define a set of license rules. Such license rules 225 may also include cost information, performance information, or other information, values, figures, or data that may be used to optimize or compare one license option to another. In other cases, a license option generator may have a set of predefined logic that uses relatively simple data expressions to define each licensing option. For example, a license analysis system may have predefined logic for handling subscription based licenses and perpetual licenses. In such a case, the license rules 225 may include variables that describe the cost and a few terms for each situation. The variables may be selected to be compatible with the predetermined logic of the license analysis system.

The license rules 225 may be used to create many different options for licensing a licensed product. Various licensing scenarios may be created using the license rules 225 and each scenario may be analyzed and optimized using cost, performance, or other factors as an optimization factor.

The license options 220 are created using the business rules 213, the usage history 219, and the license rules 225. In some instances, a single, optimized option may be presented to a user, while in other situations several options may be presented. In some embodiments, a single optimized option may be automatically selected and implemented without presenting the details to a user for approval.

The license options 220 may include options that are typical for a particular user as well as some options that are different from those used in the past. For example, a user may have a purchasing history 208, business rules 213, and usage history 219 that use perpetual licenses installed on individual client devices. While a licensing option may be presented to the user that has similar perpetual licenses, a cost and performance analysis may be performed with license options that have a per-user license or where an equivalent licensed service is provided over the Internet. The licensing options may be presented with a historical cost analysis so that various options may evaluated based on what the user's costs would have been had each option been used.

The license options 220 may be ranked, sorted, or optimized for different parameters when presented to a user. The ranking, sorting, or optimization may be performed using various business rules 213 that define a user's priorities. In some instances, cost may be a factor, while in other cases, uptime or some other performance factor may be considered for optimization. Cost, performance, complexity, or other factors may also be used in ranking or sorting various licensing options. In some cases, cost analyses may include complex financial analysis including overall cost, time value of money, financing costs, tax analysis, or any other cost analysis that may be defined in the business rules 213.

Various options created in block 220 may be presented to a user for selection. In some embodiments, an optimized option may be automatically selected and implemented, while in other embodiments, a user may be presented with various options and permitted to select an option. In some instances, a user may be able to edit, modify, or combine two or more options to select an appropriate option for block 226.

After an option is selected 226, new licenses are installed and old licenses may be returned. Various licensing schemes may have different mechanisms for installing, upgrading, or changing licenses. In some embodiments, upgrading and changing a license may be highly automated and may be performed without user intervention. In some instances, a license may be returned to a license provider so that a user may exchange one license for another or to receive a credit for an unused license.

Embodiment 200 is an example of a method for analyzing and managing licenses. In some embodiments, the method may be applied to a licensed product that is a standalone product, such as an operating system for a device. In other embodiments, the method may be applied to suites of applications or services that may involve several different services or applications. Various options may be developed that may include consolidating disparate licenses for individual applications into a license for a suite that may have additional features.

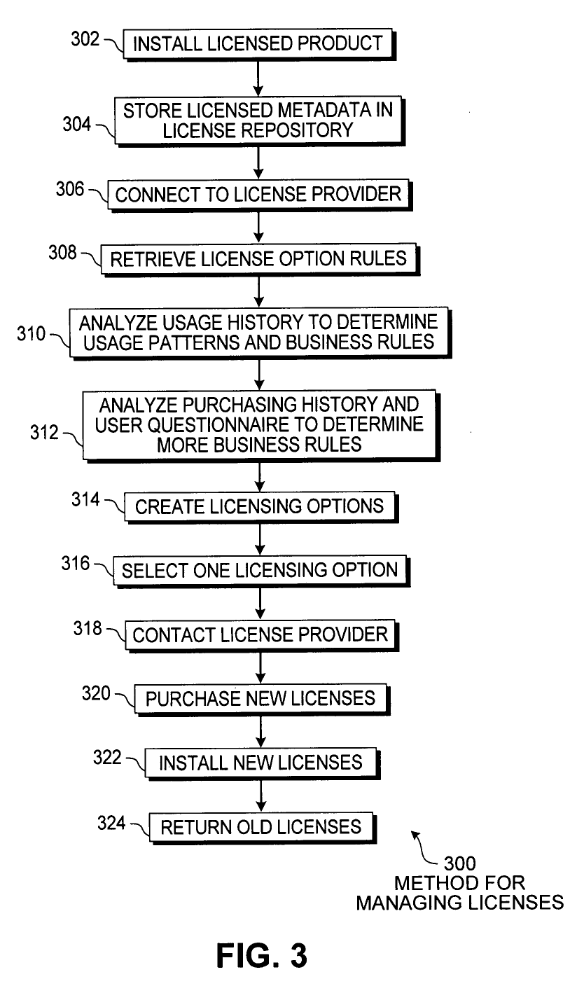

FIG. 3 is a flowchart illustration of an embodiment 300 showing a method for managing licenses.

The licensed product is installed in block 302. License metadata is stored in a license repository in block 304 at some point in time. In some instances, the installation process for the licensed product may include storing license metadata in a license repository. In other instances, a discovery routine may search a device, a network of devices, or even monitor traffic over a network gateway to determine that a new service, software, or other licensed product has been installed or is in use. The discovery routine may import metadata from a license provider, a third party database, or by querying the application directly.

A connection may be made to a license provider in block 306 and license option rules may be retrieved in block 308. The license provider may be contacted periodically by a license manager to pull license option rules, or the license provider may initiate a connection with the license manager to push license option rules to the license manager.

Usage history may be analyzed to determine usage patterns and business rules in block 310. Additional business rules may be determined by analyzing purchasing history and a user questionnaire in block 312. The analysis of usage history and business rules may allow a more useful creation and sorting of licensing options in block 314. The options may be as simple or complex as a situation may allow.

In some implementations, many different licensing options may be created and then analyzed using business rules and usage history to rank the options in order of preference. In such implementations, those options with a high preference may be presented to a user and those with a low preference may be discarded.

One of the licensing options is selected in block 316. In some instances, the selection may involve a user selecting from several options. In other instances, an optimized option may be automatically selected if it meets predetermined criteria.

The license provider is contacted in block 318 and new licenses are purchased in block 320 and installed in block 322. In block 324, any old licenses may be returned to the license provider.

The method 300 is one method by which license options may be analyzed, selected, and implemented. When automated tools are in place for retrieving and installing new licenses, in addition to returning old or unused licenses, a user may analyze a licensing program, determine the best option given the usage history and a set of business rules, and implement the option with a minimum of effort. By using an automated analysis of license options, a user may be presented with options that would not otherwise be considered. Further, special offers and changes to licensing options rules may be more readily apparent to a user and more likely that the offers or changes will be utilized.

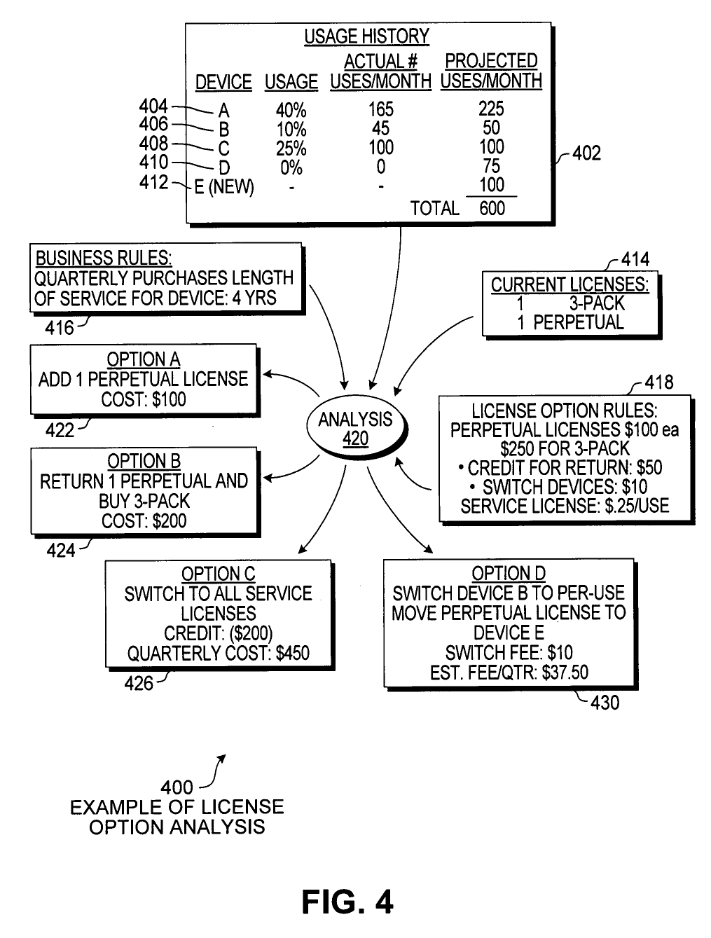

FIG. 4 is an illustration of an example 400 showing an example of a license option analysis. The example 400 is purely an example of the logic and calculations that may be performed using a license analyzer. The example 400 is fictitious but is chosen to illustrate the process and elements of the process. Those skilled in the art will appreciate that many variations may be used while keeping within the spirit and intent of the concept.

A usage history 402 contains usage data and forecast data for Device A 404, Device B 406, Device C 408, Device D 410, and Device E 412. For each device, usage is shown as a percentage, as well as actual uses per month and projected uses per month. The projected usage per month may have been entered by a user or calculated from usage history. The devices A 404, B 406, C 408, and D 410 are current devices being monitored. Device E 412 is a new device that is being added.

The current licenses 414 show that a 3-pack and 1 standalone perpetual license are currently being used.

The business rules 416 comprise the rules that purchases are made quarterly and that the length of service for any device is four years. Because the business rule states quarterly purchases, all dollar amounts in the various options may be calculated and presented on a per quarter basis. The length of service for a device may be used to calculate depreciation, estimate when a device may be upgraded and a license becomes available, or similar calculations.

The license option rules 418 include several rules. Individual perpetual licenses cost $100, while a 3-pack of licenses costs $250. When returned, a credit may be given of $50 for a license, and licenses may be switched from one device to another for $10. A service license is $0.25 per use and may provide the equivalent functionality as a perpetual license for a locally running licensed product.

Using the business rules 416, current licenses 414, usage history 402, and license option rules 418, an analysis may be performed in block 420.

Option A is shown in block 422 and consists of adding one perpetual license at a cost of $100.

Option B is shown in block 424 and consists of returning the existing one perpetual license and purchasing a 3-pack of perpetual licenses at a cost of $200. Option B has the advantage that an unused license exists if a sixth device is to be added later.

Option C is shown in block 426 and consists of switching to all service licenses and going to a per-use fee rather than a perpetual license with a fixed fee. Using option C, a credit of $200 would be issued for returning the perpetual licenses and the quarterly cost is $450, based on the projected usage of the usage history 402.

Option D is shown in block 428 and consists of switching Device B to per-use licensing and moving the perpetual license from Device B to Device E. After paying a switch fee of $10, the quarterly fee would be an estimated $37.50.

Example 400 is an example of using business rules and license option rules to compute and analyze several licensing options. The license options were calculated for a group of devices and for licensed products that may be purchased with perpetual licenses or per-use licenses. Many other license types, business rules, and usage histories may be used to calculate and analyze license options.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
storing license metadata for a licensed product in a license repository;
receiving license option rules;
determining at least a first license option, said first license option being derived from said license option rules and said license metadata;
selecting a license option;
sending a license request to a license provider to receive an updated license, said license request comprising at least a portion of said license option; and
installing said updated license in said license repository.

2. The method of claim 1 further comprising storing usage history for said licensed product in a usage database, said first license option being further derived from said usage history.

3. The method of claim 1, said licensed product comprising at least one of a group composed of:
a service provided over a network;
a locally installed software product, a software product installed on a server device and accessed over a network by a client device; and
data.

4. The method of claim 1, said metadata comprising a license type and license operational terms.

5. The method of claim 1, said receiving license option rules comprises:
establishing a connection with said license provider; and
downloading said license option rules.

6. The method of claim 1, said license option being further derived from customer business rules.

7. The method of claim 6, said customer business rules being determined at least in part by at least one of a group composed of:
deriving said customer business rules by manual input;
deriving said customer business rules by analyzing a purchase history; and
deriving said customer business rules by selecting at least a portion of a set of predetermined customer business rules.

8. The method of claim 1, said license option being further determined from a usage forecast.

9. The method of claim 1 further comprising:
determining a second license option, said first license option comprising at least one license for an installed licensed product and said second license option comprising at least one remote services license for said licensed product.

10. A computer readable medium comprising computer executable instructions adapted to perform the method of claim 1.

11. A system comprising:
a license repository adapted to store metadata about at least one license for a licensed product, said license repository comprising license option rules;
a license analyzer adapted to determine at least one license option, said license option being derived from said license option rules; and
a license retriever adapted to retrieve a new license from a license provider.

12. The system of claim 11 further comprising a usage database adapted to store usage history, said license option being further derived from said usage history.

13. The system of claim 12, said license option being further derived from a projected usage history.

14. The system of claim 13, said projected usage history being derived from at least one of a group composed of:
manual data input; and
analysis of said usage history.

15. The system of claim 11, said licensed product comprising at least one of a group composed of:
a service provided over a network;
a locally installed software product, a software product installed on a server device and accessed over a network by a client device; and
data.

16. The system of claim 11 further comprising:
a license provider interface adapted to:
establish a connection with said license provider; and
retrieve said license option rules from said license provider.

17. The system of claim 11, said license option being further derived from customer business rules.

18. The system of claim 17, said customer business rules being determined at least in part by at least one of a group composed of:
deriving said customer business rules by manual input;
deriving said customer business rules by analyzing a purchase history; and
deriving said customer business rules by selecting at least a portion of a set of predetermined customer business rules.

19. The system of claim 11, said license option being further determined from a usage forecast.

20. A license manager comprising:
a license repository comprising license metadata;
a usage database comprising usage history;
a business rules database comprising business rules;
a license rules retriever adapted to connect to a license provider and receive license option rules from said license provider;
a license analyzer adapted to derive a plurality of license options using said license metadata, said usage history, said business rules, and said license option rules; and
a license installer adapted to implement at least one of said plurality of license options.
